(19) United States
(12) Patent Application Publication
(10) Pub. No.: US 2003/0120532 A1
(43) Pub. Date: Jun. 26, 2003

(54) Use of standard formatted electronic maps for design, manufacturing and regulatory compliance

(76) Inventors: Russell Joseph Brumm, Menasha, WI (US); Thomas Walter Odorzynski, Green Bay, WI (US); Joseph Patrick Fell, Appleton, WI (US)

Correspondence Address: KIMBERLY-CLARK WORLDWIDE, INC., 401 NORTH LAKE STREET, NEENAH, WI, 54956

(21) Appl. No.: 10/034,649

(22) Filed: Dec. 26, 2001

(51) Int. Cl. G06F 17/60

(52) U.S. Cl. 705/9

(57) ABSTRACT

An electronic mapping method includes identifying a process to be completed, identifying tasks to be performed for completion of the process, and identifying required input items and output items of the process. The method further includes, in an electronic map, positioning task symbols in a standard task area of pages of the electronic map, each task symbol corresponding to a task to be performed and each task symbol being positioned below a previous task symbol on the same page to clarify process flow, associating remotely stored data with at least some of the task symbols, and in the electronic map, positioning input symbols to one side of the standard task area and positioning output symbols to another side of the standard task area to clarify process flow in the electronic map.

### BACKGROUND

The present invention relates generally to the area of process control and monitoring. More particularly, the present invention relates to use of standard formatted electronic maps for manufacturing and regulatory compliance.

Many design, manufacturing and product development processes require adherence to a predetermined process flow. The reasons for this include ensuring adequate quality of a finished product and ensuring compliance with applicable regulatory requirements. A key requirement of many regulations is that a manufacturer develop, maintain, and follow documented procedures. These procedures should provide the manufacturer with control of critical points in the life cycle of the product. These requirements apply to other processes as well as manufacturing, including product development, sales, marketing, distribution and complaint handling.

In one example, Good Manufacturing Practices or GMP is used to describe a set of principles and procedures which, when followed by manufacturers of therapeutic goods, helps ensure that the products manufactured will have the required quality. To achieve this, all stages of each design and manufacturing process must be carefully documented. Individuals carrying out the process must be trained to understand and follow the procedures.

In the past, regulatory compliance with GMP was met by writing standard operating procedure (SOP) documents for each procedure related to a regulated product. Typical SOP documents embody extensive text and graphical material to specify procedure steps, provide background material, explain context and scope, define the procedure and provide references. Writing, revising and reading the SOP documents have proved to be a laborious and time-consuming process. Ensuring that users of SOP documents are trained in the procedures is not automatic and requires separate documentation. Like any procedure, an SOP is a detailed description of how to perform a task.

Process documentation other than SOP documents has been used in the past with limited success. The use of graphic representations of processes has been well documented. Standard flow charting methods have evolved into many different formats. However, flow charting requires discipline and adherence to rules by the author in order for the finished flow chart to be useful to subsequent users. The number of flowcharting symbols can proliferate and symbol definitions can drift over succeeding flow chart generations.

Unformatted flow charts do not impose discipline in the placement of symbols on white space. While illustrated processes may flow left to right and top to bottom, they may also move from bottom to top and right to left, or combinations of these. Inputs and outputs may or may not be specified and they may be indicated only on an ad hoc basis. There is no structured syntax for reading and interpreting flowcharts in this context.

How the white space is used may also be significant. Some flow charts show operations with inputs, outputs or comments. Some show information flow, others show task flow and still others show product flow. In many cases, flow charts lack a disciplined integration of information.

Recently, electronic maps have been developed for mapping business enterprise operations. In general, these maps graphically represent a business's processes and best practices. Using a map, the business can develop, refine and communicate the processes depicted in the maps, identifying common inefficiencies, while highlighting opportunities to improve business and financial performance. Business enterprise maps are computerized flow sheets having a collection of icons having various meanings with joining symbols such as arrows and lines showing the relationships between the icons. In the graphical interface, icons on a map can represent complex processes that in turn are associated with other maps. Clicking on an icon, or following a hyperlink associated with that icon, can bring up the associated map. A map may be split across multiple pages with flow connectors or icons that link to other pages providing the needed page connections.

These maps in non-electronic form have been developed by, for example, Business Enterprise Mapping, Inc., Pritchett, LLC, vendors of Rummler-Brache systems, and Paradigm Learning. The Rummler-Brache system is a method intended to provide flexibility in the mapping format used. Work flow moves across areas of responsibility. In one example, a process may have columns for research, operation, marketing, sales and distribution. A product under development may be diagrammed as moving from a marketing column to research, back to marketing and then to operations, distribution and sales. In each column, different tasks may be performed. This mapping format is advantageous in showing cross-function interactions. However, work output, other than implied completion of a task, may not be clear. These maps are not well suited to capturing highly detailed tasks and documentation requirements. Paradigm Learning produces an illustration of a process which is a combination of an artistic rendering and high-level process steps that can quickly give a high level view of a process. However, this does not accommodate the level of detail need for a regulatory compliance application. Business Enterprise Mapping, Inc. uses a system which is more structured than unformatted flow charts. The number of symbols is large and new symbols can be created and assigned. Little text is provided in this system, which relies on a flow chart to provide process description.

Such business enterprise mapping systems have been useful for improving certain aspects of a business such as moving from product concepts to prototypes to developed materials and processes. However, to date no attempt has been made to improve corporate regulatory compliance, documentation, training and control of critical points of a business process.

### SUMMARY

By way of introduction only, the present invention provides, in one embodiment, an electronic map using formatted graphics for ensuring process compliance. The electronic map includes a template for display on a display device. The template has designated locations for process inputs, process responsibilities, process operations, process outputs and comments. The electronic map further includes a common set of symbols positionable on the template to represent the process inputs, the process responsibilities, the process operations, the process outputs and interconnecting links. The common graphical devices, in conjunction with the standard template, reduce mistakes and errors and the attendant costs associated with these when performing a process, and improve compliance and control of critical points.

The invention further provides a process control method which includes retrieving a stored electronic map associated with a process to be performed and performing tasks of the process while following the electronic map. The method further includes accessing stored information associated with the process by actuating a graphical item of the display device with a pointing device while performing the tasks of the process.

The invention further provides a visual electronic map for a process. The electronic map is displayable on a display device and includes in one embodiment standard task symbols positioned in standard locations of pages of the map. The electronic map further includes standard input symbols positioned in the standard input locations of the pages of the map and standard output symbols positioned in standard output locations of the pages of the map. The electronic map further includes connectors between symbols. The connectors, the standard locations, the standard input locations and the standard output locations are chosen to show process flow. The electronic map further includes data links between respective symbols and respective data files stored on a storage device. Each respective data file stores information related to a respective symbol associated with the respective data file.

The invention further provides an electronic mapping method which includes identifying a process to be completed, identifying tasks to be performed for completion of the process, and identifying required input items and output items of the process. The method further includes, in an electronic map, positioning tasks symbols in a standard task area of pages of the electronic map. Each task symbol corresponds to one or more tasks to be performed and each task symbol is positioned below a previous task symbol on the same page to clarify a process flow. The method further includes associating remotely stored data with at least some of the task symbols and, in the electronic map, positioning input symbols to one side of the standard task area and positioning output symbols to another side of the standard task area to clarify process flow in the electronic map.

In another embodiment, the invention further provides a regulatory compliance method for a manufacturing procedure. The method includes activating a visual electronic map on a display device and performing steps of the manufacturing procedure in conjunction with defined tasks and task ordering of the electronic map. The method further includes electronically accessing additional information when required, by linking to the additional information from the electronic map. The method further includes, upon completion of the manufacturing procedure, automatically producing a regulatory record of compliance with regulations.

The foregoing discussion of illustrative embodiments of the invention has been provided only by way of introduction. Nothing in this section should be taken as a limitation on the following claims, which define the scope of the invention.

### BRIEF DESCRIPTION OF THE DRAWINGS

FIG. 1 is an example of a template for use with an electronic mapping method;

FIG. 2 shows a symbol key, including symbols which may be placed on the template of FIG. 1 in forming an electronic map;

FIG. 3 is an example of an electronic map;

FIGS. 4-6 are a second example of an electronic map;

FIG. 7 is a flow diagram illustrating an electronic mapping method;

FIG. 8 is a flow diagram illustrating an electronic mapping method; and

FIG. 9 is a block diagram of a system on which the mapping method of FIG. 8 may be performed.

### DETAILED DESCRIPTION OF THE PRESENTLY PREFERRED EMBODIMENTS

The embodiments disclosed herein illustrate a method and apparatus by which a process is documented using a standard format and authoring protocols. In one embodiment, the process is documented in an electronic map using formatted graphics on a display device such as a computer display associated with a personal computer. The electronic map is interactive, permitting navigation using a mouse, stylus or other pointing device. The electronic map may be stored at a remote location and accessed by a user over a wireline or wireless link. The electronic map is developed or authored using a personal computer or similar device. The map is prepared using a common set of symbols which are positionable by the author on a template to represent process inputs, process responsibilities, process operations and process outputs, along with interconnecting links. The map is prepared according to rules which define the standard format.

The standard format for the electronic map includes a template with designated locations for inputs, responsibilities, operations, outputs and comments. A common and limited number of symbols are used to represent inputs, responsibilities, operations, outputs and links. The method enables the process to be defined using at least one page. Links are used to connect one part of the process to another. Links may be intra-page links or inter-page links. The method also allows links to be made between one process and another process or processes. The processes linked to the primary process can be other diagrams, text-based processes, or any other device for documenting a process. The process may also reference supplementary materials such as reference documents that may assist in completing the process.

As used herein, a process may be a procedure, method, work instruction, operation or any other series of actions or functions bringing about an end result. In one particular embodiment, a process is a procedure for manufacturing medical or consumer products in accordance with regulatory requirements, including generation of regulatory documentation demonstrating compliance with current regulations.

As used herein, regulatory procedures are not limited to medical products, but include any process subject to regulation. For example, regulatory areas include medical products procedures such as Good Manufacturing Practices (GMPs) specified by the U.S. Food and Drug Administration, Environmental Procedures such as those specified by the U.S. Environmental Protection Agency, intellectual property regulations, such as those specified by the U.S. Patent and Trademark Office, consumer products, such as those regulated by the U.S. Consumer Product Safety Commission, worker safety, such as is regulated by the U.S. Occupational Safety and Health Administration, industrial safety, such as those specified by the U.S. Nuclear Regulatory Commission, and financial regulations, such as those specified by the U.S. Securities and Exchange Commission or Internal Revenue Service. Regulatory compliance as used herein also relates to voluntary or industry standards such as those promulgated by the Cosmetic Toiletries and Fragrance Association. Regulatory compliance may also include international standards such as those established by the International Standards Organization. In addition, regulatory requirements may be imposed by individual states and countries or other supervisory organizations.

As noted, the illustrated method and apparatus have particular applicability to regulatory procedures. For regulatory procedures, it is important to delineate the process being performed as well as to identify control points critical to ensuring that the process remains compliant with the applicable regulatory controls.

The illustrated method and apparatus include several key features. First, the method and apparatus impose discipline on the author and user of a process documentation tool such as an electronic map in terms of the visual layout of symbols on the process documentation or map. By employing a common format, the user of the map can easily read and interpret the map. In one embodiment, an operation always moves from inputs on the left to outputs on the right. Supplementary information is always included in a comments section adjacent to the operation being performed. Preferably, every operation has all needed information readily available or referenced in one location, eliminating the need to flip back and forth in a document to find information such as definitions. Hypertext or other electronic links may be used to call up and display such supplementary information.

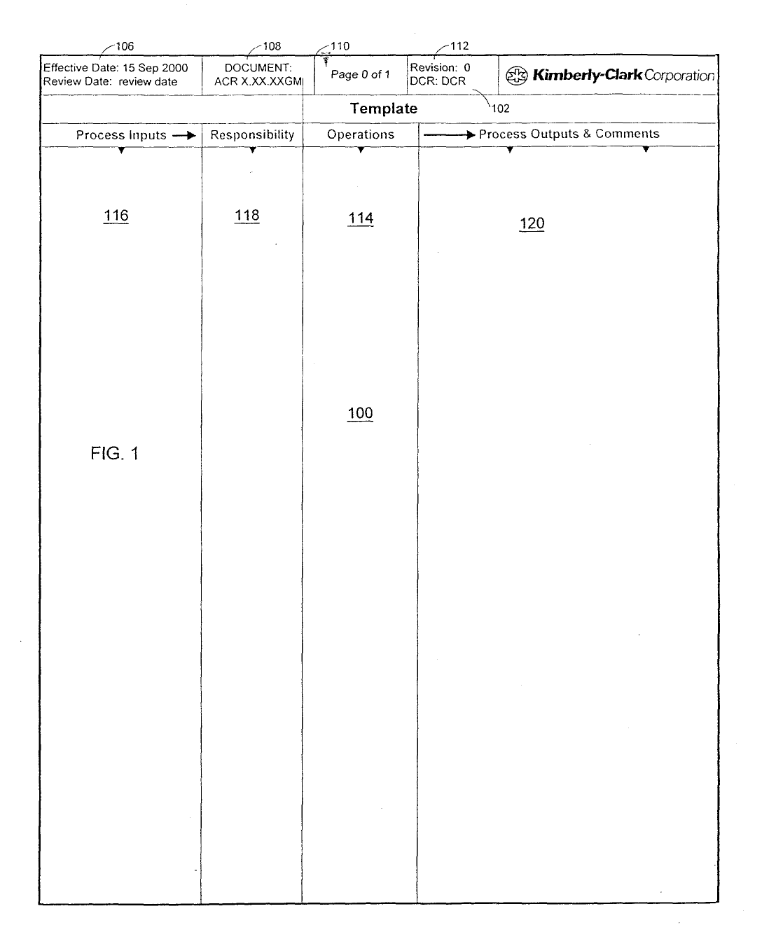

FIG. 1 illustrates an exemplary embodiment of a formatted template 100 for use in an electronic mapping method in accordance with the present embodiments. The template 100 includes predefined regions including an identification region 102 and a process definition region 104. The identification region 102 includes effective date identification information 106, document identification information 108, page information 110 and revision information 112. The information contained in these fields may be defined by the user, in the case of the effective date information 106, document identification information 108 and page number information 110. Preferably, revision information 112 is automatically updated by the system, which stores the electronic map.

The process definition region 104 in the illustrated embodiment is defined into vertical regions as illustrated across the top of the process definition region 104. Centered in the process definition region 104 is an operation definition region 114. To the left of the operation definition region 114 is a process input definition region 116. Also to the left of the operation definition region 114 is a responsibility definition region 118. To the right of the operation definition region, along the right portion of the template 100, is a process output and comment region 120.

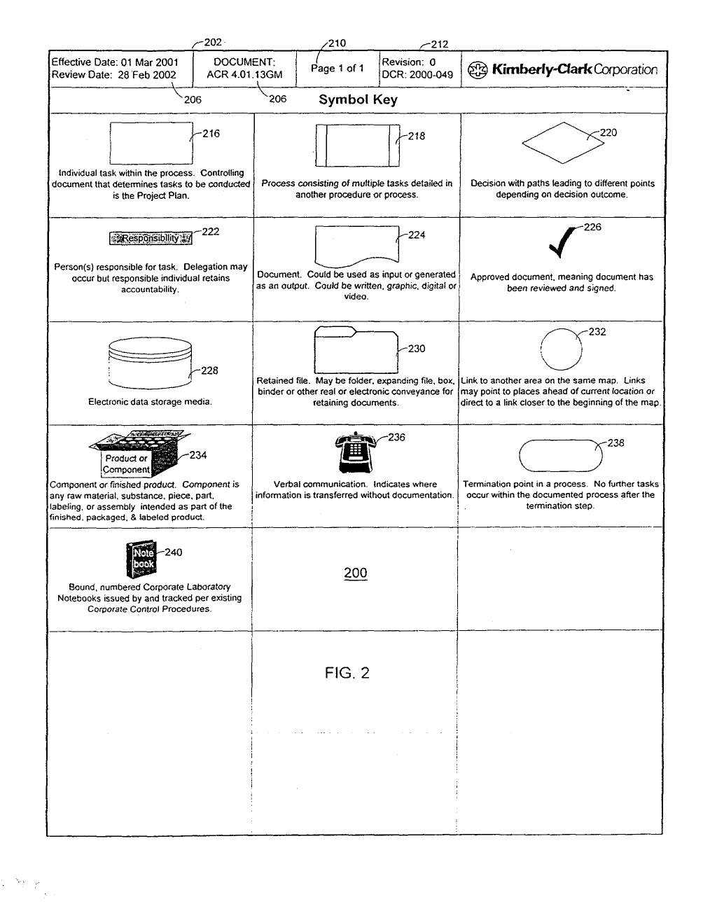

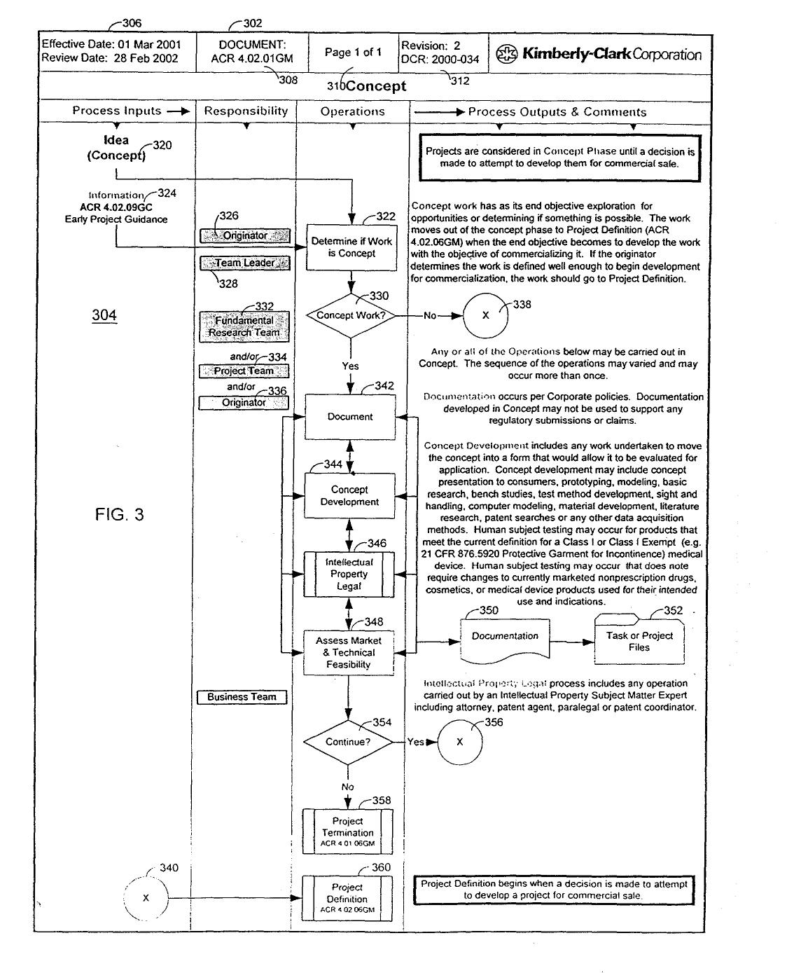

In using the template 100 to form an electronic map, appropriate symbols, such as those illustrated in FIG. 2, may be positioned in the respective regions 114, 116, 118, 120 to define process operations, inputs, responsibilities, outputs and comments, respectively. Examples of completed electronic maps will be described below in conjunction with FIGS. 3-7. The symbols positioned in the respective regions 114, 116, 118, 120 may also be interconnected with links to connect different portions of the process on one page or among more than one page. The links preferably have a directional aspect to them, illustrating flow from one symbol to another.

Thus, when authoring an electronic map using the template 100, operation symbols defining process operations are positioned in the center portion of the template 100, in the operations definition region 114. In conjunction with each symbol or other graphical item defining an operation process, any necessary process inputs may be defined to the left in the process input definition region 116. Further, the responsibilities either for providing the process inputs or for performing the process operation may be defined by placing graphical or textual information in the responsibility definition region 118. For each operation symbol or other graphical element, any produced outputs may be defined to the right in the process outputs and comments definition region 120. Also, explanatory comments and supplementary information may be positioned in this region 120 as well.

If a process requires more than a single page of an electronic map to illustrate, links may be positioned in the map at any suitable place and showing a connection to another page of the map. Navigation is assisted by the page definition region 110. The links may move in an x-y axis, analogous to the axis of the map page. That is, a link in the positive x direction may move to a map page located to the right of the illustrated map page, while a link in the negative x direction may move to a map page located below the currently displayed map page. In the drawing figure, positive x is defined to the right, and negative x is defined to the left, positive y is defined up the page and negative y is defined down the page. In this manner, an array of map pages may be created, thus adding additional organizational information as well as navigational capabilities. The pagination information contained in the page definition region may be more complex than the single integer page number shown in the exemplary embodiment of FIG. 1 to assist in navigation among the pages of the map. Further, in another embodiment, map pages may be positioned along a z axis, perpendicular to the page of the map containing the x-y axis. This defines a three-dimensional space in which symbols connect along the x and y and z axes. Three-dimensional alignment of symbols in such a map could be represented by physical or electronic models.

A second feature of the illustrated embodiments is the use of a limited number of common, predefined symbols that have the same meaning in every process diagram. Limiting the number of symbols to a predefined set reduces the chance for mix-ups, errors and misinterpretation. There is no need to provide unique symbol keys for each diagram. Once a diagram user becomes familiar with the symbols and the visual layout, the user can read and interpret any diagram.

FIG. 2 is an exemplary symbol key 200 for use with an electronic map in accordance with the present invention. The symbol key 200 is illustrated on a page including an information definition region 202 and a symbol definition region 204. The information definition region 202 includes defining information common to all map pages, including date information 206, document definition information 208, page definition information 210 and revision definition information 212.

The symbol definition region 204 includes a plurality of symbols and explanatory or defining information. In the illustrated example, the predefined symbols include an individual task symbol 216, a multiple task symbol 218 and a decision box 220. The individual task symbol 216 defines an individual task within the process that must be completed. The multiple task symbol 218 defines a process consisting of multiple tasks which are shown in detail elsewhere, in another process or procedure. Use of the multiple task symbol 218 allows nesting or sub-routining of processes, including those which are commonly used in completion of a task. The decision symbol 220 includes connectors with paths leading to different points or process symbols. The connectors show process flow depending on the outcome of the decision defined by the decision symbol 220.

The symbols in the exemplary embodiment of FIG. 2 further include a responsibility definition symbol 222, a document symbol 224 and an approved document symbol 226. The responsibility symbol defines the person responsible for completion of the task or providing an input or receiving an output. Responsibility symbols 222 would typically be positioned in the responsibility definition region 118 (FIG. 1) of an electronic map. The responsibility symbol 222 includes room for a text string defining the responsible party. The document symbol 224 defines a document which can be used as an input to process step or generated as an output from the process step. As used herein, a document can be any displayable textual, graphic, audio or video output. Alternatively, a document can be produced in printed, hard copy form.

The approved document symbol 226 may be associated with a document symbol or other similar symbol to illustrate that the document defined by the document symbol has been approved, meaning that the document has been reviewed and electronically signed by the responsible party.

The predefined symbols of the electronic map illustrated in FIG. 2 further include an electronic data storage symbol 228, a retained file symbol 230 and a link symbol 232. The electronic data storage symbol illustrates that the source of a process input or destination of a process output is some electronic data storage medium, such as a hard disk drive, CD ROM, or other similar data storage device. The retained file symbol 230 indicates a file that may be used as a source for a process input or destination for a process output. The file in one embodiment has a path name or other file designator defining how the file and its contents may be accessed. The file may include subfolders or subfiles, which can be expanded to store additional data or access to retrieve previously stored data. The link symbol 232 defines a link to another area on the same map. Links may point to places ahead of the current location or to another location closer to the beginning of the map. As noted above, links may provide navigation along any one of one, two, three or more axes of the electronic map.

The standard symbols which may be used in conjunction with the map illustrated in the embodiment of FIG. 2 further include a component or finished product symbol 234, a verbal communication symbol 236, a termination symbol 238 and a laboratory notebook symbol 240. The component or finished product symbol 234 defines a component or process input for a finished product or other process output. The component can be any raw material, substance, piece, part, labeling, assembly or information intended as part of the finished, packaged and labeled product. The verbal communication symbol 236 indicates a portion of a process where information must be transferred without documentation. Since no documentation is provided, the process step is documented solely by the symbol and other explanatory information for the user. The termination symbol 238 defines either the beginning or ending point of a process. Once the termination step defined by the termination symbol 238 has been reached, the process is ended and no further tests need be performed. The laboratory notebook symbol 240 defines the laboratory notebooks which are commonly used by engineers and scientists for tracking inventions, innovations and test data. In an electronic map, a laboratory notebook symbol 240 may serve as either an input to a process or an output to a process. As an input, data may be retrieved from a laboratory notebook for use in completion of a process. As an output, data that are produced during performance of a process may be stored or logged in a laboratory notebook. The laboratory notebook signified by the symbol 240 may be a pen and paper type of notebook or may be an electronic notebook. Preferably, the laboratory notebook is the type that is issued by and tracked in accordance with organizational control, security and intellectual property procedures.

A third feature of the electronic maps described in accordance with the present embodiment is the use of a visual interface. Users can readily see inputs, responsibility, operations, outputs and comments for each step of the process. That is, the user knows what is needed (inputs), what is being done (operation), who is doing it (responsibility), and what should be the result (output), as well as any needed explanation (comments). This feature is particularly important in procedures promulgated for the purpose of complying with certain regulatory requirements. For these procedures, work output is not just completing the predefined task, but also includes completing necessary documentation as well. A method in accordance with the present embodiments defines the documentation which must be produced in order to assure compliance with regulatory requirements.

Use of a visual interface provides substantial advantages over reproduction of information in a text-based document. In a text only environment, information needed to perform a single step in a process is often located in a variety of areas in the text document. For example, information for a single step may require the reader to locate and reference information contained in sections on materials, references, methods, definitions and calibration. All these sections may be on different pages in different parts of the procedures, or even in different volumes of text. This diffusion of information can lead to mix-ups, contamination and errors in completion of the process. In contrast, the visual interface provided by the illustrated embodiments gathers all the information required for each process step in a convenient location. Background or supplementary information may be accessed using hypertext or other links positioned on the map page proximate to the process step, the input, the output or the responsibility symbol under consideration.

A fourth advantage of the illustrated method and apparatus is that they help to ensure that processes are completed in a way that complies with the process description and requirements. All necessary information required for completion of a process step is readily available for the user of the electronic map. All necessary tasks and subtasks are clearly defined to the user. Each task and subtask must be completed prior to advancing to the next task or subtask, and the necessary outputs and documentation must be produced before advancing to the next task. This ensures an acceptable level of quality is obtained for each individual step in the process and for the overall process.

FIG. 3 illustrates one example of an electronic method for developing a concept for a new product or process. The electronic map is formatted on a single page which includes an identification region 302 and a process definition region 304. The identification region includes date information 306, document identification region 308, page information 310 and revision information 312. The effective date information is updated to show when the map becomes effective and when review of the adequacy of the map should be conducted. The document definition information 308 may be specified by the author to define the particular document. The revision information 312 is preferably automatically updated as the map is revised.

The process definition region 304 includes a plurality of symbols and text placed to define process operations, inputs, responsibility, outputs and comments for the specified process. In accordance with the template of FIG. 1, the operations symbols are positioned along a central axis of the page, process inputs are positioned to the left of the page, process responsibility is positioned between inputs and operation symbols, and process outputs and comments are positioned to the right of the page.

Describing the individual features of the exemplary map of FIG. 3, the process begins with an idea or concept 320. In this exemplary embodiment, the idea or concept may be something abstract, to be defined subsequently during performance of the concept evaluation process. The idea as an input is provided to a first operation symbol 322. An additional input, information in the form of early project guidance 324, is also provided to the symbol 322. The map specifies the party responsible for providing the early project guidance 324, the originator of the idea, specified by symbol 326. Responsibility for performing the step defined by symbol 322 is specified in the map as a team leader, symbol 328.

After completion of the step defined by symbol 322, a decision box 330 is encountered. Responsibility for performing the step defined by the decision box 330 is specified in the map as falling on the fundamental research team, symbol 332, or a project team, symbol 334, or an originator, symbol 336. The individual designated as the originator in symbol 336 also corresponds to the originator in symbol 326. The decision block 330 represents an initial determination of whether the specified concept will work. If not, a connector leads to a link 338. The link 338 is labeled x and corresponds to a link 340 near the bottom of the page.

If, at the decision block 330 it is determined that the concept will work, an interrelated group of steps, defined by symbols 342, 344, 346 and 348, is next encountered. By using appropriate connectors, it is illustrated in the map that documentation must be produced, symbol 342, in accordance with organizational policies to document development of the concept, symbol 344. A multiple task symbol 346 is included at this step to show that separate intellectual property evaluation steps must be followed. Such steps may be defined in another portion of the map and may be accessed, for example, by clicking on the symbol 346 to link to a separate map page defining those steps. Those steps may include any suitable steps such as patent searching, literature research or other data acquisition. An additional process of market assessment and technical feasibility study is defined at symbol 348.

One output produced by these processes is documentation, symbol 350. The documentation may be notes or test results or patentability search results or other information necessary for use to document completion of the process steps, for regulatory purposes or otherwise. The produced documentation is stored in task or project files, symbol 352. The stored information may be subsequently retrieved for use by the same process or by another process.

A second decision block 354 is encountered where a decision is made to continue the project. If continuation is desired, a link, symbol 356, transfers process flow to the link 340 for further action. If continuation of the concept development is not indicated, a multi-step symbol 358 is encountered, defining the group of steps required for project termination. Steps for a project termination, symbol 358, may include, for example, final documentation of the results of the concept analysis, report generation, reassignment of resources acquired for completion of this operation, etc. If, during execution of the process, a link has been made to a link defined by symbol 340, control then proceeds to a multiple task process, symbol 360, for project definition. As noted in the comment in the map, project definition begins when a decision is made to attempt to develop a project for commercial sale. The project definition steps naturally follow on after the initial concept analysis steps illustrated in the map of FIG. 3. The project definition steps, symbol 360, may be implemented in another map and may be accessed, for example, by clicking on the symbol 360.

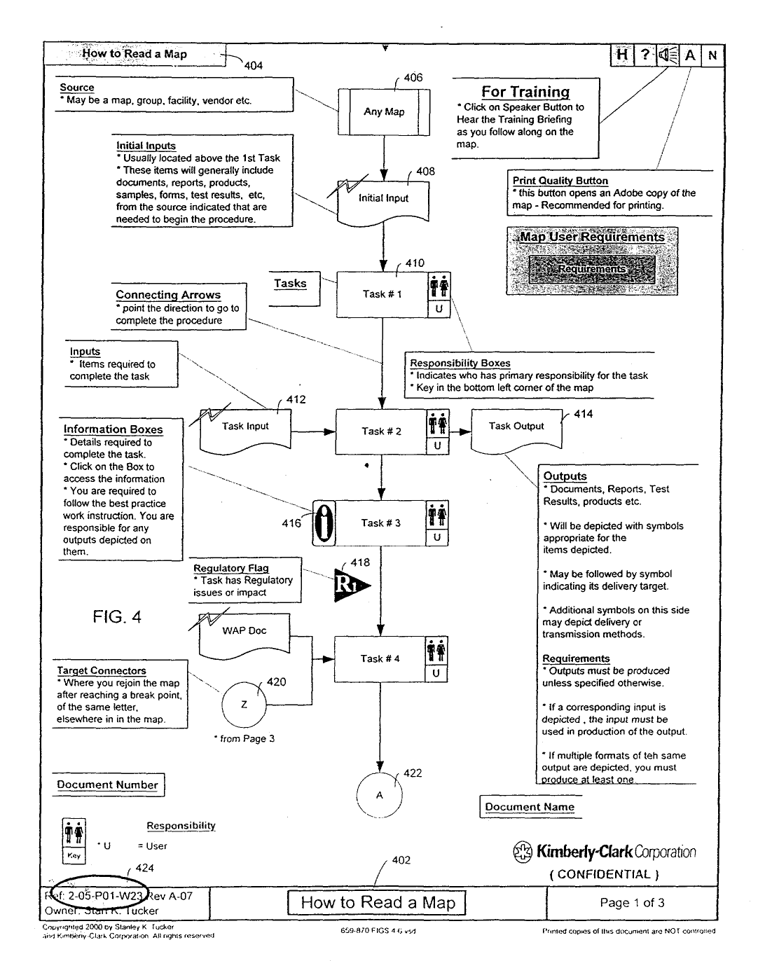

FIGS. 4-7 illustrate an alternative embodiment of an electronic map for defining and controlling a manufacturing or other process. The embodiment of FIGS. 4-7 illustrates additional features of electronic maps that provide added user convenience and reliability, particularly for documenting and performing regulatory processes.

Among these features is the association of meta-information with map content such as symbols and text on the electronic map. The map and its symbols, text and other information may be accessed using any suitable application software, such as a web browser like MICROSOFT INTERNET EXPLORER. When a symbol or text of a map is accessed, for example by clicking a mouse or other cursor control, the meta-information associated with the map content causes a predetermined response. For example, the user's browser may be re-directed to another network location where a help file in a word processing format is contained. In another example, the browser may be redirected to an audio file and sound playback equipment actuated to play the audio file.

In general, the electronic map is characterized by the ability to exchange information including data between the map and external packages such as applications, databases and other data sources and data destinations. The electronic map includes map content such as text and symbols or icons with which is associated meta-information. The meta-information is generally not displayed or available to the user of the map. However, the meta-information controls the interaction between the map and the external application or database. The external package may be located locally or remotely and accessible over a network, either by wireline or wireless communication.

Another feature of the illustrated electronic maps is the addition of online training materials linked to a map. By clicking or otherwise actuating a portion of the map, a user of the map may suspend operation or separately transfer to a training process to obtain necessary training before proceeding through the map. Another feature of the illustrated embodiment includes training verification. In accordance with this feature, use of a map or access to particular features of a map is denied unless the user has completed training. In one embodiment, denial of access to an untrained user is accompanied with simultaneously providing an opportunity for immediate online training. Another feature of the illustrated embodiment is access to audio or visual files linked to the map to provide help or other needed information. Embedded or linked documentation is accessible to the user of the map by clicking icons on the map in accordance with the meta-information of the electronic map. The documentation may include files such as word processing documents or text files, video sequences, audio files or stationary visual files such as computer based presentations.

Another feature of the illustrated embodiment is the addition of electronic forms linked to relevant portions of a map. Examples are regulatory forms or a form that must be completed to register for equipment training, health screening and the like. Another feature of the illustrated embodiment is a device for adding data to files associated with a map. An example is the ability to enter data into a database or spreadsheet dealing with manufacturing results or material property test results. Data relevant to process can be stored in a common place accessible by all users or by any desired subset of the users of the map or form.

In an additional feature, the illustrated embodiment is a device for adding text documents, such as monthly reports for a project, to a folder associated with the process. This may include, for example, clicking on a folder icon on a map that provides access to a directory on a server where reports or other documents can be uploaded, downloaded, edited or otherwise manipulated and modified by appropriate users. In addition, these operations can be coupled with electronic tracking of document changes to show who made additions or revisions and when.

An additional feature of the illustrated embodiments is a device for electronically signing forms or database entries using any suitable electronic signature tool. Also, the illustrated embodiment provides the ability for complex searching of data and text. Also, the illustrated embodiment provides a visual means for tracking projects, such as display of red, yellow or green lights or other colored symbols for a given project displayed in conjunction with the symbol for each stage of the process. Appropriate color coding provides additional information for the user.

These advantages and others provided by the illustrated embodiments provide better control over personnel training, better control over document generation and storage, improved productivity through online, on-demand training associated with the process, more rapid updating of procedures, better forms handling, and so forth.

In one embodiment, icons in a map of manufacturing or other processes are linked to actual documents detailing test methods or other procedures, or to database sets such as a spreadsheet of data providing information related to the process. Thus, the map is no longer a mere graphical depiction of process, but is directly linked to documents such as text or databases that pertain to various aspects of the process. Data and other information may be exchanged between the electronic map and the external document or other files.

In one embodiment, the software system ensures that users of the map have been trained to read the map. After logging on and activating the electronic mapping software system, the software system checks to see if the user has been trained with the skills needed for a particular map. This is an example of data interchange between the particular map and an external file, such as a file containing training records for the individual user. If the user seeks to access a map or features for which training has not been obtained, access is denied and the user is presented with an opportunity for online training at that point. The user can then proceed with training, including taking an optional test to verify skill acquisition, followed by granting of access to the map or function for which training has been obtained.

Online training integrated with the map software allows rapid updates in training and rapid delivery of training to the user. In the past, training for each map was provided by scheduling a meeting with the users and an instructor. Scheduling conflicts made this a time-consuming process and an inefficient use of instructor resources. Now the instructor or programmer can modify the online training when a new feature is added or some other change has been made in the maps. The changed help file triggers changes in the access log for the system. Users that have not been trained in the new feature will not be allowed to use it until they have added the needed training. This can be brief training on only the added feature. Alternatively, the needed training may be training on the entire map, depending on the preference of the manager of the software system.

FIG. 4 shows page 1 of a three-page map illustrating conventions used in one embodiment of an electronic map for documenting a process to be performed. The map includes an identifier box 402 in the lower center of the page and an identifier box 404 in the top left corner of the page. The identifier boxes make identification of the map simple for the user and may be updated or otherwise controlled by the author of the map.

Each map is formed from a group of standard map symbols. Symbols illustrated in FIG. 4 include a source symbol 406, an initial input 408, a task symbol 410, a task input 412, a task output 414, an information box 416, a regulatory flag 418 and connectors 420, 422. The source symbol 406 defines a source of information, products, parts, etc. to be operated on. As noted in FIG. 4, the source associated with the source symbol 406 may be a map, a group, a facility, a vendor, etc. The initial input defined by the initial input symbol 408 may be items such as documents, reports, products, samples, forms, test results, and so forth from the source defined by the source symbol 406 which are needed to begin the process defined by the map. The lightning bolt associated with the initial input symbol 408 indicates that the initial input is an electronic source such as a data file.

The task symbol 410 defines a task to be completed in the process. Task boxes such as the task box 410 include text defining the task to be completed. Also, in one embodiment, the task box 410 may be clicked or otherwise actuated to provide access to other information related to the task. Other information may be text-defining background information about the task or other suitable information. Associated with the task box 410 is a responsibility box which indicates the party having primary responsibility for completion of the task. As noted in the map of FIG. 4, the responsibility box is keyed to the list of possible responsible parties in the lower left corner of the map. In the illustrated embodiment, the responsible party is the user, indicated by the letter U. Other possible keys include the letter R, corresponding to a researcher, the letters SA, corresponding to a study agency, the letter Q corresponding to quality assurance personnel and the letter T corresponding to a test lab or other facility. Other responsible parties may be indicated as well. The individual task boxes and input and output boxes are connected by connecting arrows which illustrate the process flow through the procedure defined by the map.

The input box 412 defines task inputs required to complete a particular task. The symbol 412 for the task input indicates that that input is an electronic document. The task output associated with symbol 414 may be any suitable output, such as a document, a report, test results, products, etc. Preferably, task outputs are depicted with meaningful symbols appropriate for the items depicted.

In addition, the destination for the output may also be depicted by including in the map a symbol indicating the destination. The map of FIG. 4 illustrates other requirements in accordance with one embodiment of the map. That is, outputs must be produced by a task unless otherwise specified. If an input is depicted, the input must be used in production of the corresponding output during performance of a task, and if multiple formats of the same output are depicted, the user must produce at least one output.

An information box 416 is shown in association with one task box. The information box is configured to be clicked or otherwise actuated to access information associated with the task. For example, the information box may call up a document, an audio or visual file providing details required to complete the task. After viewing the information provided, the user may return to the map to continue performance of the process.

Symbol 418 shows a regulatory flag, indicating that the task to be performed has regulatory issues or impact. A regulatory flag such as the flag 418 may serve to heighten awareness of the user of the regulatory impact of the task. Alternatively, encountering a regulatory flag such as the flag 418 may initiate parallel processes such as data recording, documentation or other actions required to satisfy regulatory requirements. The regulatory flag may provide a link to explanatory information about the regulatory impact or regulatory requirements. Alternatively, the regulatory flag may provide a link to an internet location operated by the regulatory authority, such as the U.S. Food and Drug Administration or an industry regulatory body.

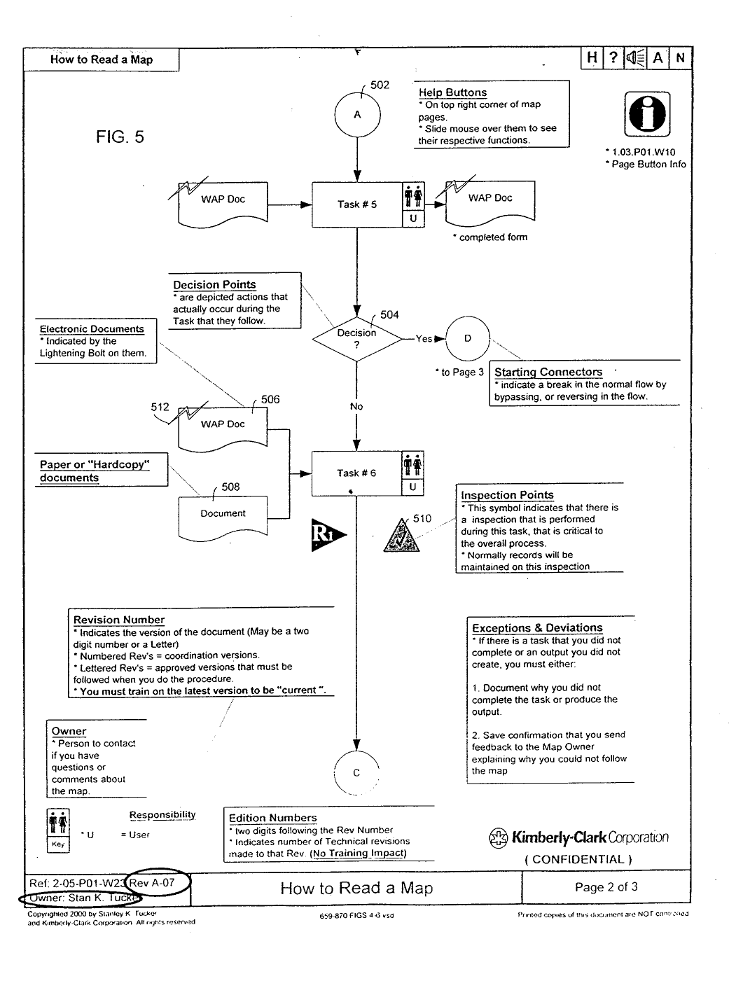

As noted above in conjunction with FIG. 1, each map page may be one portion of a much larger map. To facilitate navigation among pages of the map, connectors such as connector 420 and connector 422 are provided. By using a mouse to click on the connector 422, the user is taken to the corresponding target connector on a separate page, in this case connector 502, FIG. 5.

FIG. 4 also shows additional user convenience features in accordance with one embodiment of an electronic map. A document number 424 is provided in the lower left corner of the map. The document number provides ready identification of the electronic map. Preferably, revision information is included as well and an owner of the electronic map is identified. In the event of requirement of additional information, the owner may be separately contacted by the user. In the upper right corner of the map, several clickable buttons are provided for user convenience. In the illustrated example, the H button may be clicked to redirect the user's computer to the map home page or the highest level process for the current area. The ? button may be clicked to access help files. The help files are preferably keyed to the map page and provide additional information about the process or task. The button including a graphical symbol of a speaker may be actuated to provide an audio or visual file providing additional help or background information. The button labeled A may be actuated to provide a printout of the map or a single map page. The button labeled with the letter N may be actuated to send a note or other feedback to the owner of the map. For example, clicking the N button may open up a window in an electronic mail program with a destination address set to be the electronic mail address of the map owner. The user is then prompted to enter text to provide the necessary feedback to the map owner.

FIG. 5 shows additional features of electronic maps in accordance the illustrated embodiment. FIG. 5 illustrates a decision block 504, an electronic document 506, a paper or hard copy document 508 and an inspection point 510. A decision block such as decision block 504 illustrates a choice or option should be selected based on the results of the task executed immediately before the decision block. The decision block typically has multiple outputs. In the illustrated embodiment, yes/no options are provided. In other embodiments, other numbers of outputs may be provided as well and may be designated numerically or by letters or in any other suitable fashion.

The document boxes 506, 508 illustrate the difference between electronic documents and paper or hard copy documents as illustrated in the map. The electronic documents are indicated by an associated lightning bolt 512. The inspection point 510 indicates that there is an inspection that is performed during the associated task and that the inspection and results thereof are critical to the overall process. Normally, records will be maintained as part of this inspection. Accordingly in some tasks having an associated inspection points, output documents may be generated or stored.

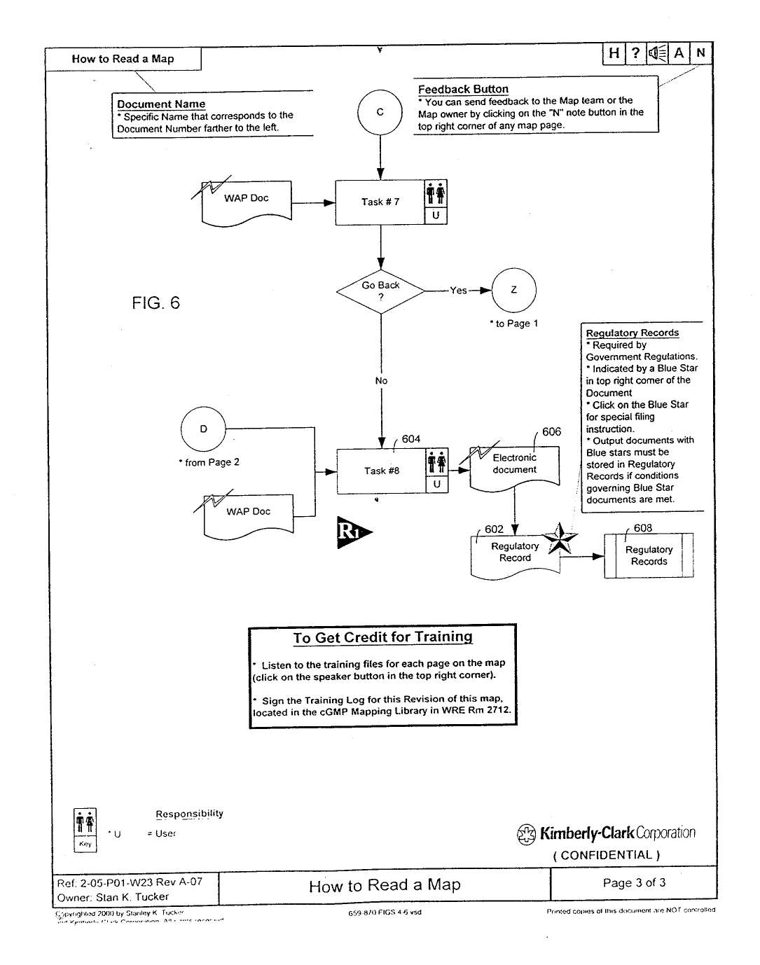

FIG. 6 illustrates a third page of the second embodiment of an electronic map. Particularly illustrated in FIG. 6 is generation of regulatory record 602. As a result of a task 604 performed during the processing of the procedure described by the electronic map, an electronic document 606 is generated. Based on the electronic document, a regulatory record 602 is created and stored with other regulatory records 608. Regulatory records in general are required by government regulations. For example, the regulatory record may include test results which must be submitted to a regulatory authority such as the Food and Drug Administration or the Federal Communications Commission. In the illustrated embodiment, the regulatory record is graphically indicated on the electronic map by showing a star in the top right corner of the symbol for the regulatory record 602. In one embodiment, by clicking on the star or by otherwise actuating the regulatory record, the user may obtain special filing instructions, or other information or processes associated with regulatory procedures and compliance. It will be understood that the electronic mapping techniques described herein may be adapted to any suitable process. Other types of symbols may be developed or the symbols illustrated herein may be modified to provide other functionality.

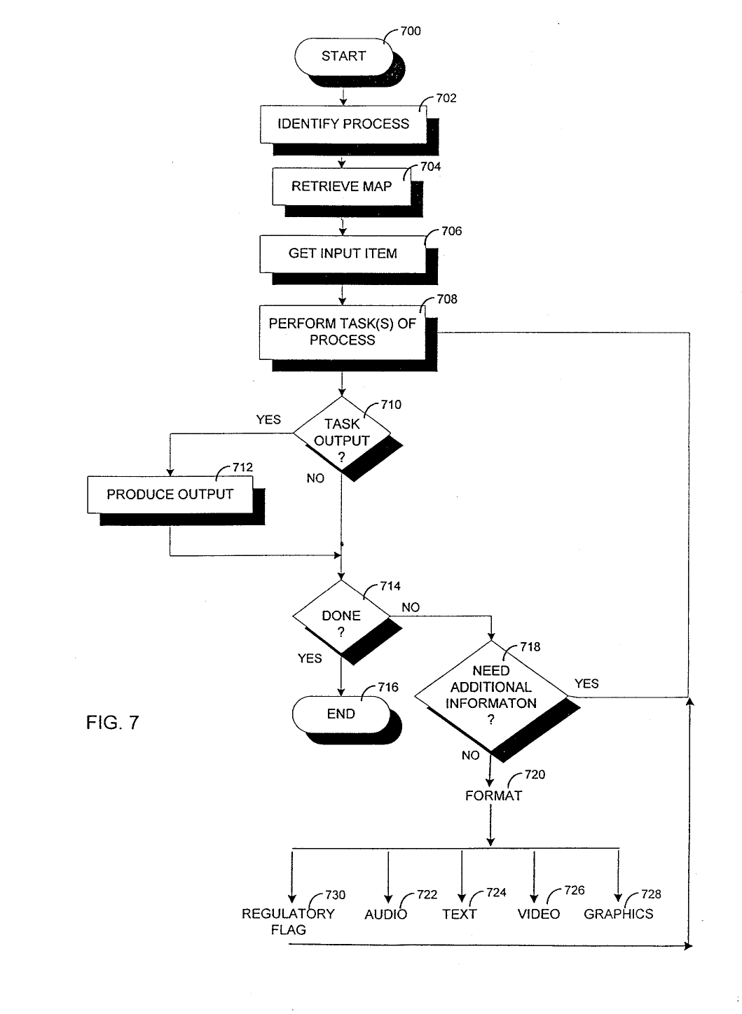

FIG. 7 is a flow diagram illustrating a process control method employing electronic maps in accordance with the present embodiments. The method begins at block 700. At block 702, the process to be performed is identified. This may be done, for example, by typing in a process identifier in an electronic mapping program, or by other suitable means. At block 704, an electronic map associated with the identified process is retrieved from storage. In one example, stored data corresponding to the map are retrieved over a network from a database and used to display an electronic map on a data processing device such as a personal computer. It will be appreciated that other types of data processing devices may be substituted, such as a handheld personal digital assistant. At block 706, one or more initial input items as designated by the electronic map are retrieved. These initial input items may be electronic information such as data or files or documents, or may be external information.

The method continues at block 708, where tasks of the process are performed. Where initial input items have been retrieved, block 708 includes operating on the one or more initial input items as designated by one or more tasks shown on the electronic map. The one or more initial items may include at least one of a document, a report, a product, a sample, a form or test results from a source indicated by the electronic map. In typical applications, performing tasks of the process in accordance with block 708 of FIG. 7 includes following the electronic map on a display device, performing the tasks or steps in the order specified by the map using the inputs specified by the map and generating the outputs specified by the map. This may be a wholly electronic process wherein the map is consulted in one window of a processing system, then another window is selected to operate data and documents in accordance with the specified task of the process. Alternatively, the map as displayed on an electronic device such as a computer monitor may only provide directions for operating on a wholly external process, such as a manufacturing process or a test and data gathering process. In an alternative embodiment, performing tasks of a process may include printing the electronic map on one or more pages and following the electronic map on the one or more printed pages, in conjunction with performing the tasks of the process on the inputs to produce the outputs.

Performing tasks of the process in accordance with block 708 may further include retrieving one or more task input items as designated by the electronic map. This may include, for example, retrieving a document, a report, a product, a sample, a form or test results from a source indicated by the electronic map. The task input items are then operated on as designated by tasks shown on the electronic map. Performing tasks of the process may further include producing a task output as designated by the electronic map.

While performing tasks of the process, tasks may require production of one or more output items as designated by the electronic map. At block 710, it is determined if task outputs should be produced. If not, control proceeds to block 714. However, if task outputs should be produced, at block 712, output is produced, for example in the form of a document, test results, a report or a product. The product map will designate the format of the output to be produced by the task. Further, in conjunction with block 712, producing output may involve delivering output items to a delivery target as designated by the electronic map. For example, a document may be electronically mailed to an intended recipient. Alternatively, data may be formatted for a spreadsheet program and stored in a database for subsequent use. Other types of output delivery may be substituted as well.

At block 714, it is determined if the process is finished. If so, the method ends at block 716. In conjunction with termination of the method, process outputs may be generated. For example, a document, test results, a report or a product may be generated and conveyed to a designated recipient or destination.

If the process does not terminate, control proceeds to block 718 where it is determined if additional information is required. While performing tasks of the process, the method may include accessing the stored information associated with the process, for example, by actuating a graphical item of the display device with a pointing device such as a mouse or cursor. Accessing stored information in this manner may involve retrieving stored electronic documents for use in association with performing tasks of the process, retrieving one or more documents containing information required for a task of a process, or retrieving one or more documents containing explanatory information about a task of the process. In some embodiments, accessing stored information may involve retrieving audible or visual information to provide a training briefing for a user while following the electronic map. In still other embodiments, accessing stored information may involve clicking a hyperlink associated with a task and displaying stored information associated with the task in response to the hyperlink click. Clicking the hyperlink may access stored information or may redirect a browser of the user's computer to another internet location, such as a regulatory agency web site. In one embodiment particularly suited for regulatory compliance, accessing stored information includes clicking a regulatory flag hyperlink associated with a task, displaying explanatory information about the regulatory significance of the task, and displaying a hyperlink to a regulatory agency web site associated with the task. At block 720 the proper format for displaying the additional information is determined. Exemplary formats include audio format 722, text format 724, for example in the form of a word processing file, video format 726, such as a video file displayed on a computer, and graphics format 728, such as a slide presentation displayed for training or informational purposes on the work station. Alternatively, in one embodiment, the information may be displayed in a regulatory flag format 730, including explanatory information about the regulatory significance of a task and a hyperlink to a regulatory agency web site. After formatting and presentation of the additional information, control returns to block 708 to perform a subsequent task of the process. The method continues until all of tasks of the process have been completed and all necessary outputs have been generated.

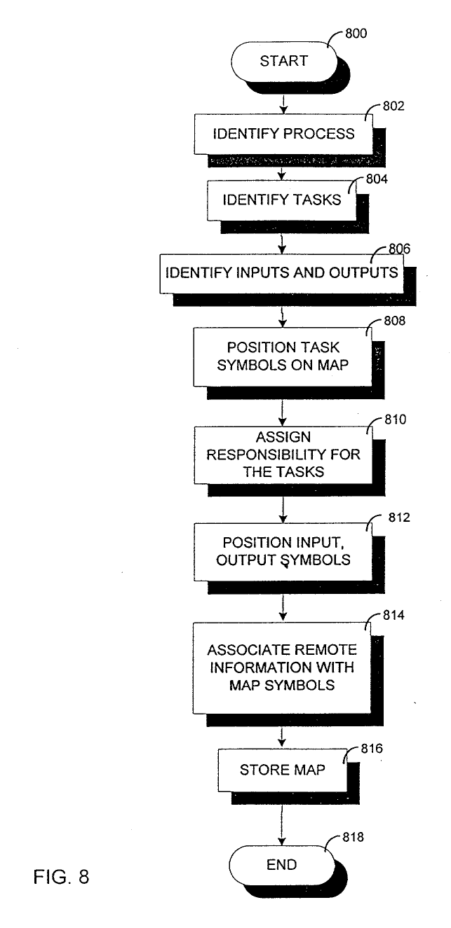

FIG. 8 is a flow diagram illustrating one embodiment of an electronic mapping method. The method of FIG. 8 may be used to create an electronic map for documenting a process in standard format. The method begins at block 800. At block 802 the process to be mapped is identified. At block 804, the tasks necessary to complete the process are identified. At block 806, input items to be provided in completion of the tasks, along with the output items to be produced by the tasks of the process are also identified.

At block 808, the task symbols are positioned on the electronic map. In accordance with the present embodiments, the task symbols are positioned in a standard task area of pages of the electronic map. Each task symbol corresponds to a task to be performed. Alternatively, some task symbols may correspond to multiple tasks or other processes to be performed. Each symbol is positioned below a previous task symbol on the same page to clarify process flow. Thus, process flow is down a page, from top to bottom, in the order in which reading is typically performed. At block 810, input and output symbols are positioned on the map. The input symbols are positioned to one side of the standard task area, such as the left hand side, and output symbols are positioned to another side, such as the right hand side of the standard task area to clarify process flow in the electronic map. Thus, process flow from input to a task to an output is from left to right, in accordance with the way in which items are usually read. Preferably, the task symbols, the input symbols and the output symbols are common to a family of electronic maps.

At block 812, remote information is associated with map symbols. The remote information may be stored data, files, documents, and any other information that may be required in performing tasks of the process. In one embodiment, associating remotely stored information with map symbols may include hyperlinking a symbol with data or with a network location or web site. In another embodiment, associating the remotely stored data with map symbols includes linking online training materials for a task with a task symbol. That is when a task symbol or other information on map is selected, for example by clicking with a mouse or pointer, the linked training materials are accessed for use by a user. In yet another embodiment, the method may include verifying training and performance of the task by an electronic map operator before completion of the task. In a still further embodiment, associating the remote information with map symbols may include linking a symbol to online documentation files with additional information about the task associated with a symbol. In yet another embodiment, associating remote information may include, after completion of the task, transferring data from the electronic map to a form data file for preparation of a completed form for the process, or other generation of output from a task or the process.

In another embodiment, the method includes positioning task symbols and input symbols or output symbols on a first map page as well as on second map page. The method then includes positioning link symbols on the first map page and associating page link symbols on the second map page with respective page link symbols on the first map page. This permits navigation between the first map page and the second map page.

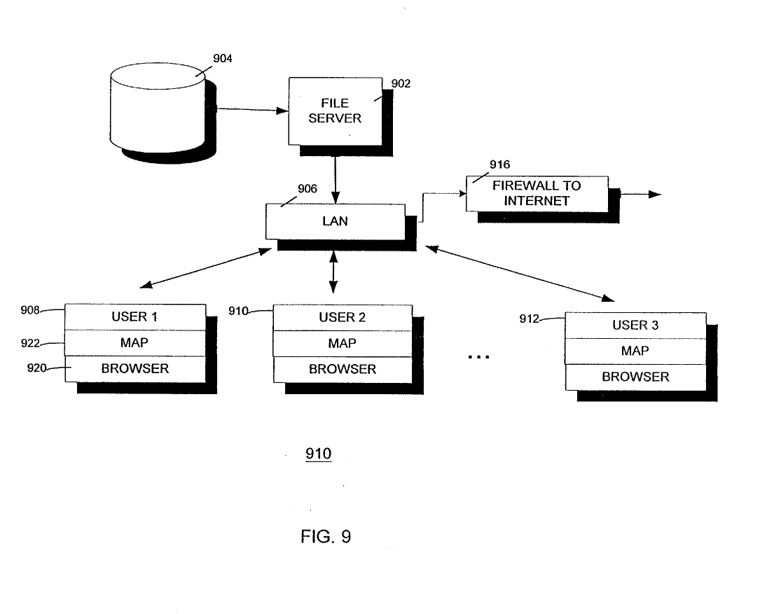

FIG. 9 is a block diagram of an exemplary system for data processing and electronic mapping in accordance with the embodiments described herein. The system 900 includes a file server 902, a map database 904, local area network 906, a plurality of users 908, 910, 912 and a firewall 914.

The file server 902 is preferably a server computer providing high speed access to data stored in the map database 904 by the users 908, 910, 912. In one embodiment, the file server 902 is a Microsoft Internet Information Server, available from Microsoft Corporation, Redmond, Wash. Alternatively, the file server 902 can be implemented as any computer that can operate under control of software such as Microsoft Internet Explorer or other Microsoft file server program, or similar application. Some of the documents stored on the map database 904 are stored in appropriate formats for the nature of the document, such as MICROSOFT WORD word processing documents, MICROSOFT EXCEL spreadsheet documents and MICROSOFT POWERPOINT presentation documents.

The local area network 906 provides high-speed communication between the users 908, 910, 912 and the file server 902, as well as the firewall 914. Any suitable local area network may be implemented.

The users 908, 910, 912 may be any suitable data processing device. A typical, exemplary device is a personal computer operating under the MICROSOFT WINDOWS operating system available from Microsoft Corporation. The computer further includes the Internet Explorer web browser program 920 and a map program 922. Other types of data processing devices may be substituted as well. In addition, one or more of the users 908, 910, 912 may be a portion of a device performing a process which is mapped in an electronic map. For example, the user 910 may be a data processing device, including processor and storage, which are part of a manufacturing line for manufacturing products. To provide operator instruction for the manufacturing process or a sub-process within the manufacturing process, the electronic map is provided to the operator to follow the steps of the process, completing the tasks of the process using the inputs specified by the electronic map and producing the specified outputs. In alternative embodiments, the users 908, 910, 912 may be wirelessly linked with the file server 902 to provide immobile capability.

The firewall 914 provides controlled access between the users 908, 910, 912 and the internet. As noted above, some regulatory procedures may require access to web sites provided by regulatory agencies, such as the Food and Drug Administration or industry compliance organizations. In this matter, an operator using the web browser 920 of a user device 908 can access information over the internet.

From the foregoing, it can be seen that the present embodiments provide method and apparatus for electronic mapping of processes for regulatory compliance and control. A process is documented using a standard format and graphical devices. Locations for inputs, outputs and operations are standardized on a template and a common but limited number of symbols are used to represent actions within a task. As tasks are completed, and documentation must be produced, the documentation is generated automatically simply by following the specified tasks of the process. Training is ensured for users of the system by maintaining a training log. If a user lacks the necessary training to complete a process or a task within a process, the operation is suspended until the training is obtained. Training is provided in a direct, online manner, including a variety of information conveyance channels, such as audio, video and graphical formats. In this manner, regulatory compliance is ensured and the process is standardized to reduce cost and time delays.

While a particular embodiment of the present invention has been shown and described, modifications may be made. It is therefore intended in the appended claims to cover all such changes and modifications which fall within the true spirit and scope of the invention.

1. A process control method comprising:
retrieving a stored electronic map associated with a process to be performed;
performing tasks of the process while following the electronic map; and
while performing the tasks, accessing stored information from files external to the electronic map and associated with the process by actuating a graphical item of the display device with a pointing device.

2. The method of claim 1 wherein accessing stored information comprises:
clicking a hyperlink displayed on the display device;
retrieving a file stored at a location indicated by the hyperlink;
presenting user information on the display device using the retrieved file.

3. The method of claim 1 wherein accessing stored information comprises:
retrieving a stored electronic audio file for use in association with performing the tasks of the process.

4. The method of claim 1 wherein accessing stored information comprises:
retrieving a stored electronic video file for use in association with performing the tasks of the process.

5. The method of claim 1 wherein accessing stored information comprises:
retrieving a stored electronic document for use in association with performing the tasks of the process.

6. The method of claim 5 wherein retrieving stored electronic documents comprises:
retrieving one or more documents containing information required for a task of the process.

7. The method of claim 5 wherein retrieving stored electronic documents comprises:
retrieving one or more documents containing explanatory information about a task of the process.

8. The method of claim 1 wherein accessing stored information comprises:
retrieving audible information to hear a training briefing while following the electronic map.

9. The method of claim 8 wherein accessing stored information further comprises:
retrieving visual information associated with the audible information of the training briefing.

10. The method of claim 1 wherein performing tasks of the process comprises:
retrieving one or more initial input items as designated by the electronic map; and
operating on the one or more initial input items as designated by one or more tasks shown on the electronic map.

11. The method of claim 10 wherein retrieving one or more initial input items comprises:
retrieving at least one of a document, a report, a product, a sample, a form and test results from a source indicated by the electronic map.

12. The method of claim 10 further comprising:
retrieving one or more task input items as designated by the electronic map; and
operating on the one or more task input items as designated by one or more tasks shown on the electronic map.

13. The method of claim 12 wherein retrieving one or more task input items comprises:
retrieving at least one of a document, a report, a product, a sample, a form and test results from a source indicated by the electronic map.

14. The method of claim 1 further comprising:
while performing the tasks, producing one or more output items as designated by the electronic map.

15. The method of claim 14 wherein producing one or more output items comprises producing task output as designated by the electronic map.

16. The method of claim 14 wherein producing one or more output items comprises producing a process output as designated by the electronic map.

17. The method of claim 14 wherein producing one or more output items comprises producing at least one of a document, test results, a report and a product as designated by the electronic map.

18. The method of claim 14 wherein producing one or more output items comprises actuating a feedback button of the electronic map to communicate task information to a map maintainer.

19. The method of claim 14 further comprising conveying the one or more output items to a delivery target in accordance with the electronic map.

20. The method of claim 1 wherein accessing stored information comprises:
using a browser application, clicking a hyperlink associated with a task;
redirecting the browser application to a location indicated by the hyperlink;
initiating a new application external to the electronic map; and
displaying stored information associated with the task using the application external to the electronic map.

21. The method of claim 1 wherein accessing stored information comprises:
clicking a regulatory flag hyperlink associated with a task;
displaying explanatory information about the regulatory significance of the task.

22. The method of claim 21 wherein accessing stored information further comprises:
displaying a hyperlink to a regulatory agency web site associated with the task.

23. The method of claim 1 wherein retrieving a stored electronic map comprises:
initiating a computer application on a data processing device;
accessing a stored file containing data defining the electronic map; and
using the data, producing a map display on the display device.

24. A visual electronic map for a process, the electronic map being displayable on a display device and comprising:
standard task symbols positioned in standard locations of pages of the map;
standard input symbols positioned in standard input locations of the pages of the map;
standard output symbols positioned in standard output locations of the pages of the map;
connectors between symbols, the connectors, the standard locations, the standard input locations and the standard output locations chosen to show process flow; and
data links between respective symbols and respective data files stored on a storage device, each respective data file storing information related to a respective symbol associated with the respective data file, the data links including training links to training material stored in a data file and accessible by actuating one or more of the training links.

25. The visual electronic map of claim 24 further comprising:
responsibility symbols positioned adjacent related task symbols to indicate a party responsible for performance of a task associated with the task symbol.

26. An electronic mapping method comprising:
identifying a process to be completed;
identifying tasks to be performed for completion of the process;
identifying required input items and output items of the process;
in an electronic map, positioning task symbols in a standard task area of pages of the electronic map, each task symbol corresponding to a task to be performed and each task symbol being positioned below a previous task symbol on the same page to clarify process flow;
associating remotely stored data with at least some of the task symbols, including linking online training materials for a task with a task symbol; and
in the electronic map, positioning input symbols to one side of the standard task area and positioning output symbols to another side of the standard task area to clarify process flow in the electronic map.

27. The electronic mapping method of claim 26 wherein the task symbols, the input symbols and the output symbols are common to a family of electronic maps.

28. The electronic mapping method of claim 26 wherein associating comprises hyperlinking a symbol with data.

29. The electronic mapping method of claim 26 further comprising verifying training in performance of the task by an electronic map operator before completion of the task.

30. The electronic mapping method of claim 26 wherein associating comprises linking at least one of online audio files, video files or static display files for playback to and electronic map operator.

31. The electronic mapping method of claim 26 wherein associating comprises linking a symbol to online documentation files with additional information about the task associated with the symbol.

32. The electronic mapping method of claim 26 further comprising:
positioning task symbols and at least one of input symbols and output symbols on a first map page;
positioning additional task symbols and at least one of output symbols and input symbols on a second map page;
positioning page link symbols on the first map page; and
associating page link symbols on the second map page with respective page link symbols on the first map page for navigation between the first map page and the second map page.

33. The electronic mapping method of claim 26 wherein the page link symbols are positioned to align one of an x axis and a y axis of the first map page with a like axis of the second map page.

34. The electronic mapping method of claim 33 wherein the page link symbols are positioned to align a z axis of the first map page with a z axis of the second map page.

35. A regulatory compliance method for a business process, the method comprising:
activating a visual electronic map on a display device;
training a user using training information electronically linked to the electronic map;
performing steps of the business process in conjunction with defined tasks and task ordering of the electronic map;
when required, electronically accessing additional information by linking to the additional information from the electronic map; and
upon completion of the business process, producing a regulatory record of compliance with regulations.

36. The regulatory compliance method of claim 35 further comprising:
verifying a training status of the user before providing access to one or more tasks of the electronic map.

37. The regulatory compliance method of claim 36 further comprising:
assessing the user's qualification before providing access to one or more tasks of the electronic map.

38. The regulatory compliance method of claim 36 further comprising:
comparing the user's training history with training requirements for one or more tasks of the electronic map.

39. The regulatory compliance method of claim 36 further comprising:
providing on the electronic map a regulatory flag for tasks having a regulatory impact in the business process.
